(19) United States
(12) Patent Application Publication
(10) Pub. No.: US 2011/0200701 A1
(43) Pub. Date: Aug. 18, 2011

(54) PLATEN FOR AN INJECTION MOLDING MACHINE

(76) Inventor: Carsten Link, Burlington (CA)

(21) Appl. No.: 13/045,034

(22) Filed: Mar. 10, 2011

Related U.S. Application Data
(63) Continuation-in-part of application No. 12/973,372, filed on Dec. 20, 2010, now abandoned.
(60) Provisional application No. 61/288,624, filed on Dec. 21, 2009.

(51) Int. Cl. B29C 45/66

(52) U.S. Cl. 425/193

(57) ABSTRACT

A platen for supporting a mold portion in an injection molding machine comprises a mounting plate having a front face for supporting a mold portion, and a rear face spaced apart from the front face. The mounting plate has vertically spaced apart top and bottom horizontal margins, and horizontally spaced apart vertical margins. The vertical and horizontal margins generally intersect at four respective corners of the mounting plate. Four tie bar connection bosses are affixed to the rear face. Each tie bar connection boss is positioned at one of the corners of the mounting plate. Four peripheral walls extend rearwardly from the rear face of the mounting plate for transferring a clamping load from the tie bar connection bosses to the mounting plate. Each peripheral wall has a length parallel to the front face and has opposed ends joined to respective adjacent ones of the tie bar connection bosses.

This application is a continuation-in-part of U.S. patent application Ser. No. 12/973,372, filed Dec. 20, 2010, which claims the benefit of Provisional Application No. 61/288,624, filed Dec. 21, 2009, each of which is hereby incorporated herein by reference.

### FIELD

The specification relates to injection molding machines, elements thereof, and methods and apparatuses for supporting mold portions and/or removing molding articles from mold portions in an injection molding machine.

### BACKGROUND

U.S. Pat. No. 5,593,711 (Glaesener) discloses a platen for use in a clamping operation wherein a force is generated having a first direction. The platen includes a first wall having edges and a center area and at least first and second sides, wherein the first side is adapted to be positioned nearest the clamping operation. The platen further includes a second wall spaced from and substantially parallel to the first wall, wherein the first and second walls extend substantially transverse to the first direction of the force. An intermediate support structure is positioned between the walls and is used to direct the force from the edges of the first wall toward the center area of the first wall for substantially preventing non-uniform deflection of the first wall along the first side.

U.S. Pat. No. 5,776,402 (Glaesener) discloses an injection molding machine that includes a stationary platen having a first mold half, at least one movable platen having a second mold half for forming a mold with the first mold half, tie bars for guiding the movable platen relative the stationary platen, and an injection unit for injecting molten resin into the mold. For at least one of the stationary and movable platen, a force is generated during clamping that has a first direction. The at least one stationary and movable platens includes a first wall having edges and a central area and at least first and second sides, wherein the first side is adapted to be positioned nearest the clamping operation. The platen further includes a second wall spaced from and substantially parallel to the first wall, wherein the first and second walls extend substantially transverse to the first direction of the force. An intermediate support structure is positioned between the walls and is used to direct the force from the edges of the first wall toward the central area of the first wall for substantially preventing non-uniform deflection of the first wall along the first side. A related process for preventing flash formation is also disclosed.

U.S. Pat. No. 6,171,097 (Urbanek) discloses a device for injection molding of plastics which has one stationary and one moveable die platen, and a mechanism for producing a closing force between the half moulds carried by the die platens. The closing force is introduced exclusively into selected areas of a supporting frame adjacent longitudinal spars and spaced apart from one another, and the ends of the spars are connected by tension bars.

U.S. Pat. No. 7,080,978 (Glaesener) discloses a platen for a molding machine that includes an intermediate support structure between two planar walls having ribs arranged at a non-normal angle beta to a first wall. The ribs couple forces from the first wall to the second wall in such a way that bending of the second wall is resisted. This adds to the rigidity of the second wall and hence the platen, adding to flatness of the arrangement. Gussets may be provided extending between the ribs and the intermediate support structure. This has the effect of surrounding and supporting an injection bore and further adding to the coupling of forces to the edge portions of the second wall to resist forces acting to bend the wall.

U.S. Published Pat. Appn. No. 2008/0175944 (Teng et al.) discloses a platen of a molding system, a molding system having a platen, a clamp of a molding system having platens and a molded article.

### SUMMARY

The following summary is intended to introduce the reader to various aspects of the applicant's teaching, but not to define any invention. In general, disclosed herein are one or more methods or apparatuses related to injection molding, and to supporting molds and/or ejecting parts from molds in injection molding machines.

According to one aspect, a platen for supporting a mold portion in an injection molding machine is provided. The platen comprises a mounting plate having a front face for supporting a mold portion, and a rear face spaced apart from the front face. The mounting plate has vertically spaced apart top and bottom horizontal margins, and horizontally spaced apart vertical margins. The vertical and horizontal margins generally intersect at four respective corners of the mounting plate. Four tie bar connection bosses are affixed to the rear face of the mounting plate. Each tie bar connection boss is positioned at a respective one of the corners of the mounting plate. Four peripheral walls extend rearwardly from the rear face of the mounting plate for transferring a clamping load from the tie bar connection bosses to the mounting plate. Each peripheral wall has a length parallel to the front face and has opposed ends joined to respective adjacent ones of the tie bar connection bosses.

Each peripheral wall may extend generally linearly along a respective one of the margins of the mounting plate.

The rear face of the mounting plate and an inner face of each peripheral wall may cooperate to define a platen cavity. At least a portion of the platen cavity may define a central volume for receiving an ejector plate. The central volume may have a depth that is greater than a stroke length of the ejector plate, so that the ejector plate is received within the central volume in both an advanced and a retracted position.

The platen may further comprise at least one buttress within the platen cavity. Each buttress may extend rearward from the rear face of the mounting plate and laterally from an inner face of at least one peripheral wall for transmitting a portion of the clamping load between the mounting plate and the at least one peripheral wall. Each buttress may be connected at an axial end to the rear face of the mounting plate and laterally to at least two peripheral walls.

Bores may pass through the mounting plate and the tie bar connection bosses for receiving a respective tie bar therethrough. Each bore may be parallel to a platen axis extending orthogonal to the front face.

Each tie bar connection boss may have a proximal boss end near the mounting plate and a distal boss end spaced rearward of the proximal end. A first portion of each proximal boss end may be joined to the rear face of the platen and a second portion of the proximal end may be spaced apart from the rear face.

Each tie bar connection boss may be connected to the rear face via the respective peripheral walls, and substantially the entire proximal boss end may be spaced apart from the rear face of the mounting plate.

The four peripheral walls may comprise two spaced apart horizontal walls and two spaced apart vertical walls extending between the tie bar connection bosses. Each peripheral wall may have a height parallel to a platen axis. The height may extend orthogonally from a proximal wall end joined to the mounting plate to a distal wall end spaced rearwardly from the proximal wall end.

At least one peripheral wall may comprise at least one aperture passing therethrough. The at least one peripheral wall may comprise three apertures spaced along a length of the peripheral wall. Each peripheral wall may comprise an inner wall face and an outer wall face, and the at least one aperture may extend from the inner wall face to the outer wall face.

At least one of the peripheral walls may comprise an ejector mount for at least partially supporting an ejector assembly.

Each of the tie bar connection bosses may house a locking member for axially locking together the platen and a respective tie bar passing through the respective tie bar connection boss.

At least one runner may extend laterally outward from the platen for slidably supporting the platen on an injection molding machine rail.

The platen may further comprise an ejector plate. The rear face of the mounting plate and an inner face of each peripheral wall may cooperate to define a platen cavity. At least a portion of the platen cavity may form a central volume. The ejector plate may be movably received within the central volume.

According to some aspects, a combination of a platen assembly for an injection molding machine and an ejector assembly mounted to the platen is disclosed, in which the combination comprises: a) a mounting plate having a front face for supporting a mold portion, and a rear face spaced apart from the front face, the mounting plate having vertically spaced apart top and bottom horizontal margins and horizontally spaced apart vertical margins, the vertical and horizontal margins generally intersecting at four respective corners of the mounting plate; b) four tie bar connection bosses affixed adjacent the rear face of the mounting plate, each tie bar connection boss positioned at a respective one of the corners of the mounting plate; c) four peripheral walls extending rearwardly from the rear face of the mounting plate for transferring a clamping load from the tie bar connection bosses to the mounting plate, each peripheral wall having a length parallel to the front face and having opposed ends joined to respective adjacent ones of the tie bar connection bosses; wherein the rear face of the mounting plate and an inner face of each peripheral wall cooperate to define a platen cavity, at least a portion of which defines a central volume; and d) an ejector plate movable between advanced and retracted positions, the ejector plate disposed within the central volume when in and moving between the advanced and retracted positions.

In some examples of the combination, the axial distance between the advanced and retracted positions of the ejector plate defines a stroke length, and the central volume may have an axial extent that is greater than the stroke length of the ejector plate, and the ejector plate may be disposed within the axial extent of the central volume in both the advanced and retracted positions.

In some examples, the combination may comprise a backstop oriented parallel to the mounting face and disposed rearwardly of the platen cavity, the backstop fixed relative to the platen and at least partially supporting a linear actuator for urging the ejector plate between the advanced and retracted positions. The actuator may comprise a motor mounted vertically beneath a lower horizontal one of the peripheral walls. The backstop may comprise a lower portion extending vertically below the elevation of the lower peripheral wall, and the motor may be mounted to the lower portion of the backstop.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is an isometric view of an injection molding machine including a platen;

FIG. 2 is an enlarged isometric view of the clamp drive of the injection molding machine of FIG. 1;

FIG. 3 is a front isometric view of the moving platen of FIG. 1;

FIG. 4 is a rear isometric view of the moving platen of FIG. 1;

FIG. 5 is a cross section taken along line 5-5 in FIG. 3;

FIG. 6 is a top plan view of the moving platen of FIG. 1;

FIG. 7 a front isometric view of an alternate moving platen;

FIG. 8 is a rear isometric view of the moving platen of FIG. 7;

FIG. 9 is a cross section taken along line 9-9 in FIG. 7;

FIG. 10 is a rear isometric view of an alternate example of a moving platen in combination with an ejector assembly; and

FIG. 11 is a section view of the combination of FIG. 10 taken along the lines 11-11.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

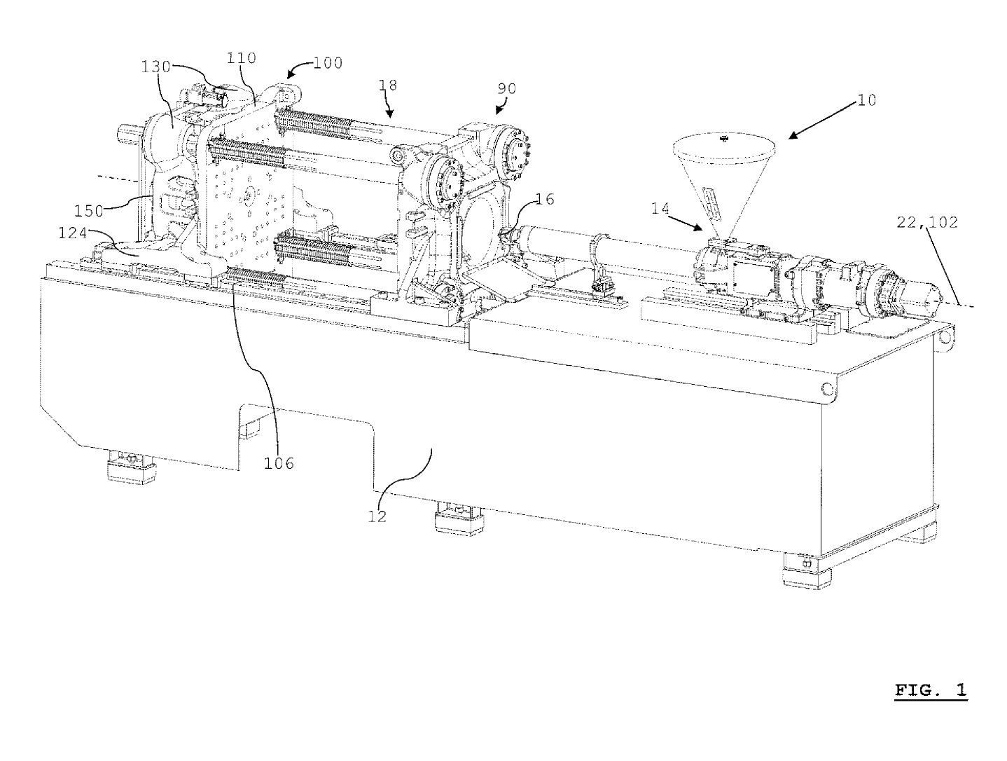

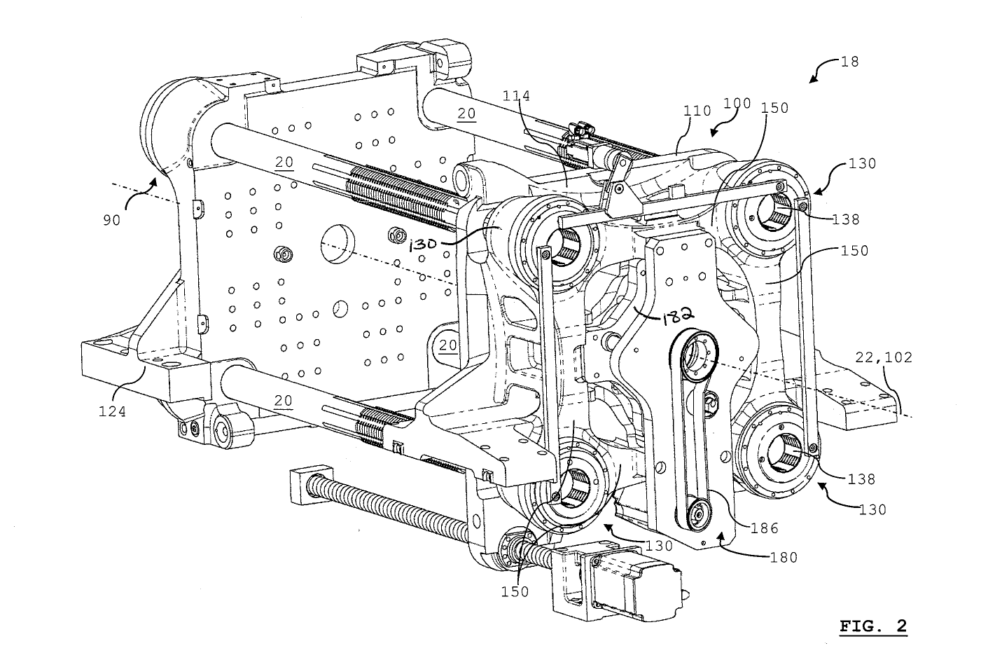

An example of an injection molding machine 10 is illustrated in FIG. 1. The injection molding machine 10 includes a base 12, an injection unit 14 mounted to the base 12, and a clamp drive 18. The injection unit 14 has a nozzle 16 at one end to inject material into a mold. The mold includes mold portions (not shown) that are supported by the clamp drive 18. Referring to FIGS. 1 and 2, the clamp drive 18 includes platens for supporting the mold portions. The platens include a stationary (or fixed) platen 90 fixed to the base 12 adjacent the nozzle 16, and a moving platen 100 facing the fixed platen 90, opposite the nozzle 16. The moving platen 100 is slidable along the base 12 away from and towards the fixed platen 90 for opening and closing the mold.

Referring still to FIGS. 1 and 2, a plurality of tie bars 20 extend between the stationary 90 and moving 100 platens for exerting a clamping force across the mold to hold the mold in the closed position during an injection cycle. The tie bars 20 extend parallel to a machine axis 22, and the translation of the moving platen 100 is parallel to the machine axis 22. In the example illustrated, the machine axis 22 passes through the center of the nozzle 16. The moving platen 100 has a platen axis 102 that is colinear with the machine axis 22 when the platen 100 is mounted to the machine 10.

The moving platen 100 may be slidingly supported on a rail 106 of the injection molding machine 10 by at least one runner. Referring still to FIGS. 1 and 2, in the example shown, the moving platen 100 is slidingly supported on a pair of rails 106 by a pair runners 124, and is movable between open and closed positions (the open position is shown in FIGS. 1 and 2). The rails 106 extend from a rear support (not shown) towards the stationary platen 90. In the example illustrated, as the moving platen 100 moves along the rails 106, it moves relative to the machine tie bars. While the tie bars 20 are received within bores 126, 136 in the moving platen (explained in more detail below) the weight of the platen 100 is carried by the rails 106. In other examples, the tie bars can be fixed to, and moveable with, the moving platen.

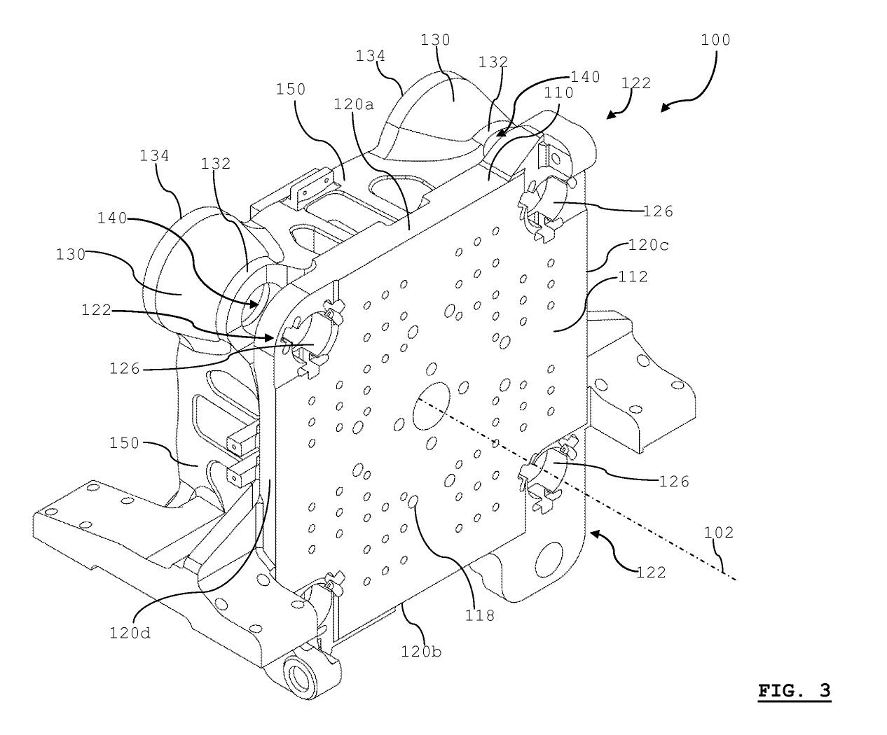

Referring now to FIG. 3, the moving platen 100 comprises a mounting plate 110 having a front face 112 directed towards the fixed platen 90. The front face 112 is for supporting a mold portion, and is configured to have a mold portion mounted thereto. In the example illustrated, the front face 112 is generally planar, and oriented orthogonal to the platen axis 102.

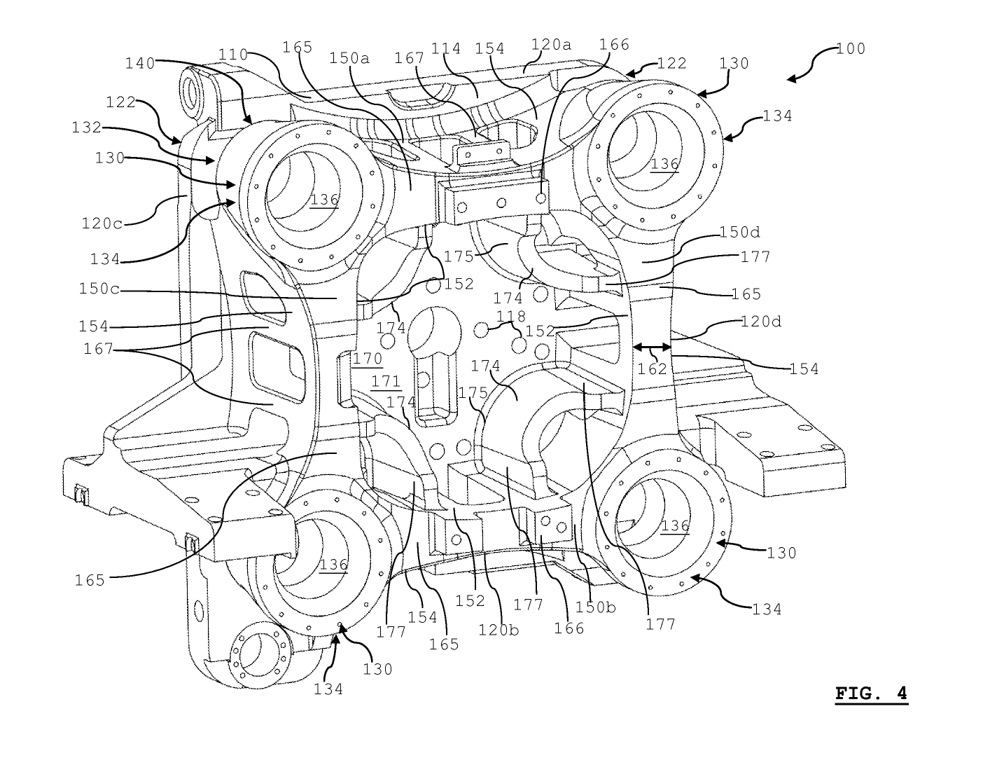

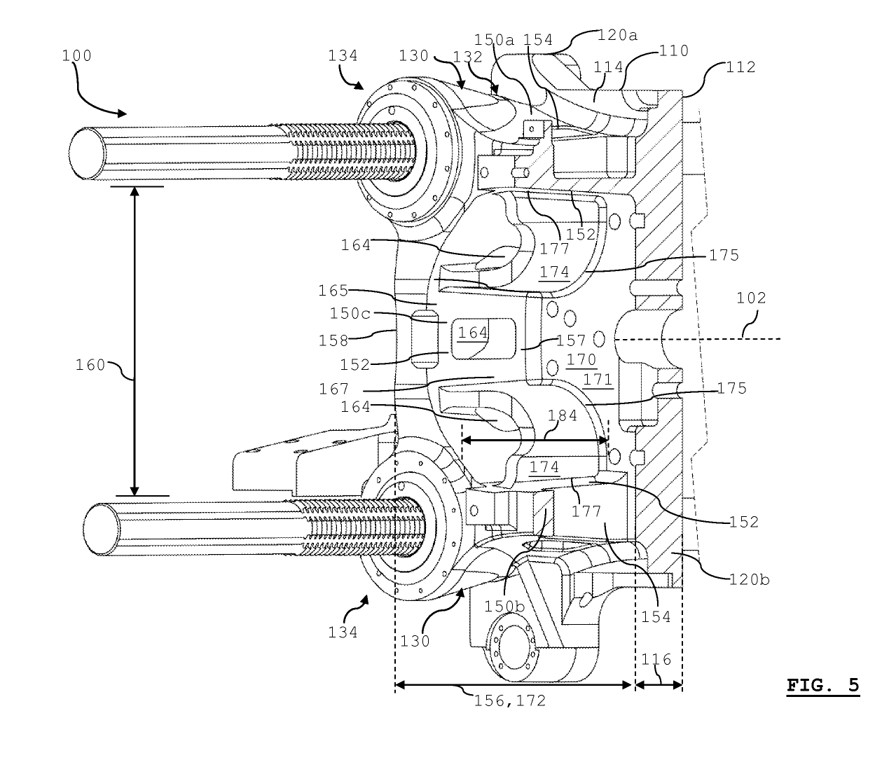

Referring to FIG. 4, the mounting plate 110 has a rear face 114 spaced apart from the front face 112 (in the axial direction), away from the fixed platen 90. The axial spacing between the front 112 and rear 114 faces defines a mounting plate thickness 116 (shown in FIG. 5). In the example illustrated, the rear face 114 is generally parallel to the front face 112, providing a generally constant thickness 116 across most or all of the mounting plate 110. The mounting plate thickness 116 can be selected to suit a particular machine size or clamp load application, and, in some examples, can be in the range of about 50 mm to about 250 mm or more. In the example illustrated, the plate thickness 116 is in the range of about 100 mm to about 120 mm.

Referring still to FIGS. 3 and 4, in the example shown, a plurality of through-holes 118 pass through the mounting plate 110 (i.e. extend from the front face 112 to the rear face 114). The through-holes 118 may, for example, receive mounting hardware for attaching the mold portion to the front face 112 of the mounting plate 110 (such as screws, bolts, rivets, pins, etc.), or receive ejector pins or rods (or any other suitable ejecting device) that are used to eject the finished part from the mold, or mold portion. The through-holes 118 in the mounting plate 110 may be of any suitable number, size, and arrangement as required to operate a particular mold or particular injection molding machine. In some examples, in addition or alternatively to the through-holes 118, the mounting plate 110 may comprise a plurality of blind-holes (i.e. holes that do not extend through both the front and rear faces 112, 114).

Referring still to FIGS. 3 and 4, in the example shown, the mounting plate 112 has a generally square or rectangular shape when viewed along the platen axis 102, and comprises four margins 120 extending about the periphery of the mounting plate. The margins 120 include a horizontal top margin 120a and a horizontal bottom margin 120b, which are vertically spaced apart, and a first vertical side margin 120c and a second vertical side margin 120d, which are horizontally spaced apart. The margins 120a, 120b, 120c, 120d, generally intersect at four respective corners 122 of the mounting plate. The corners 122 of the platen 100 illustrated are rounded to form a corner radius. In other examples, the platen corners may comprise sharp edges, chamfers or other suitable geometries. Further, in other examples the platen may include mounting plates of a different shape having a greater or fewer number of edges and corners (e.g. hexagonal or triangular shaped mounting plates).

Referring to FIGS. 4 to 6, in the example shown, the moving platen 100 further comprises a plurality of tie bar connection bosses 130, which are affixed to the rear face 114 of the mounting plate 110. As shown, the moving platen 100 comprises four tie bar connection bosses 130. Each tie bar connection boss 130 is positioned at a respective corner 122 of the mounting plate 110, for engaging a respective tie bar 20. Each tie bar connection boss 130 comprises a proximal end 132 (or proximal boss end) that is near the mounting plate 110 and a distal end 134 (or distal boss end) that is spaced rearwardly (i.e. away from the stationary platen) of the proximal end 132, away from the mounting plate 110. In the example illustrated, the tie bar connection bosses 130 are integrally formed (i.e. in a casting) with the mounting plate 110. In other examples, one or more of the tie bar connection bosses can be separately attached directly or indirectly to the mounting plate.

Referring to FIG. 4, as shown, each tie bar connection boss 130 comprises a bore 136 passing therethrough and extending from the proximal end 132 to the distal end 134, for receiving the respective one of the tie bars 20. The bore 136 of each tie bar connecting boss 130 is generally aligned with (i.e. concentric with) a corresponding bore 126 (shown in FIG. 3) which passes through the mounting plate 110, and which also receives the respective one of the tie bars. Each of the bores 136, 126 extends parallel to the platen axis 102. Aligning the mounting plates bores 126 with tie bar connection boss bores 136 enables each tie bar 20 to pass through both the mounting plate 110 and the tie bar connection boss 130 as the platen 100 moves along the rails 106.

Referring still to FIG. 4, each bore 126, 136 may be sized and configured to freely receive one of the tie bars 20 therein, or each bore 126, 136 may be configured to slidably or threadingly engage one of the tie bars 20. In the example illustrated the bores 126, 136 are sized to freely receive the tie bars 20 therein.

The tie bar connecting bosses 130 can each comprise a tie bar locking member 138 for engaging the tie bars 20 and for axially locking together the moving platen 100 and a respective tie bar 20 passing through the respective tie bar connection boss 130. The tie bar locking members 138 are each moveable between an unlocked position in which the respective tie bar 20 can pass freely through the respective bores 126, 136, and a locked position in which relative axial movement between the respective tie bar 20 and the mounting plate is restricted.

In the example shown the tie bar locking member 138 comprises a lock nut or bayonet that is rotatably mounted adjacent the distal end 134 of each tie bar connecting boss 130. When in the locked position, axial rows of teeth on an inner surface of the bayonet engage rows of corresponding teeth formed on the outer surface of the tie bars 20. When rotated to the unlocked position, the bayonet teeth are aligned with slots in the tie bar teeth so that relative axial movement between the tie bars 20 and platen is unrestricted.

In other examples, the platen 100 may include additional or different tie bar locking members, such as, for example, but not limited to, half-nuts, friction clamping devices, or similar devices. Additionally or alternatively, all or a portion of the tie bar connection bosses 130 may be fixedly attached to the tie bars 20. In further examples, the tie bars may be fixed to the moving platen 100 (in a non-releasing fashion during operation of the machine), and may be releasably coupled to an opposing platen (e.g. stationary platen 90).

When the injection molding machine 10 is in use, a clamping force (i.e. a mold clamp force) is exerted on the tie bars 20 in order to draw together the moving platen 100 and the stationary platen 90. When the tie bar locking member 138 is in the locked position, the clamping force exerted on the tie bars 20 is transferred to the tie bar connection bosses 130 via the tie bar locking members 138. The clamping force is further transferred or distributed from the tie bar connection bosses 130 to the mounting plate 112, and ultimately to the mold portion attached thereto.

With reference to FIGS. 4 to 6, to facilitate transfer of the clamping load from the tie bar connection bosses 130 to the mounting plate 112, four peripheral walls 150 are provided, each of which extends rearwardly from the rear face 114. The four peripheral walls 150 extend generally linearly along the periphery (i.e. along margins 120) of the mounting plate 110. Each wall 150 extends between, and has opposed ends joined to, respective, adjacent tie bar connection bosses 130 (i.e. to tie bar connection bosses 130 that are provided along the same margin 120 of the mounting plate 110, rather than to tie bar connection bosses that are at diagonally opposite corners).

In the example illustrated, the details of the attachment by which the connection bosses 130 are affixed to the mounting plate 112, and the configuration of the peripheral walls 150 cooperate to provide a force transferring structure that can help to (i) avoid applying an excessive, concentrated load at the corners of the platen, and (ii) leave a central portion of the rear face of the mounting plate open (i.e. substantially clear of any webs or struts) to accommodate an ejector mechanism. These features are described in greater detail below.

In the example illustrated, each tie bar connection boss 130 is positioned at a respective corner 122 of the mounting plate 110, and has at least a portion of the proximal end 132 spaced apart from the mounting plate. Another portion of the proximal end 132 of each tie bar connection boss 130 can be affixed directly to the mounting plate 110.

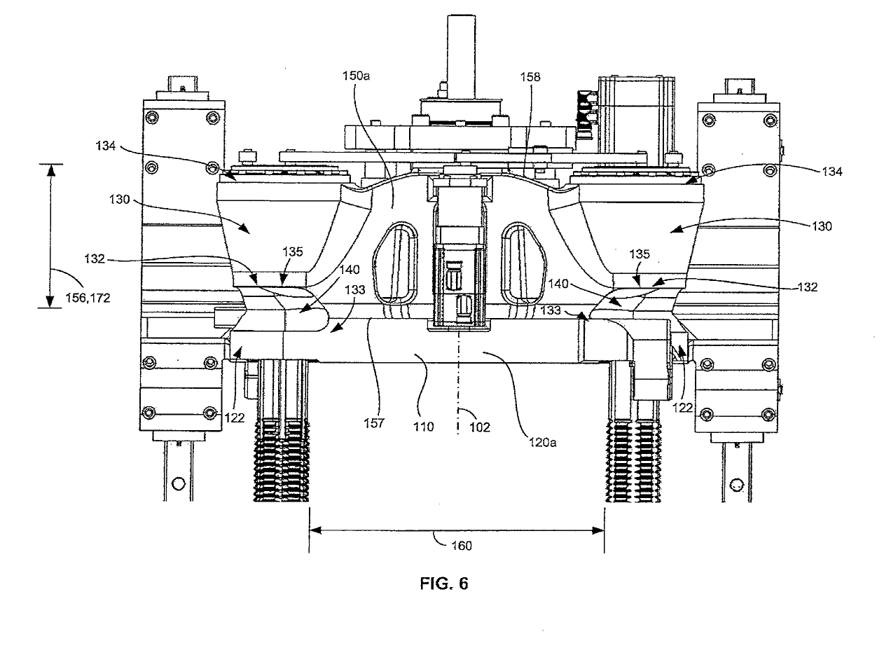

As seen in FIG. 6, at least a portion of the proximal ends 132 of the tie bar connection bosses 130 are not connected to, and are spaced apart from, the rear surface 114 of the mounting plate 110. In the example illustrated, each proximal end 132 comprises a first portion 133 that is joined to the rear face, and a second portion 135 that is spaced apart from the rear face. In the example illustrated, the free, spaced-apart portion (i.e. second portion 135) of the proximal end 132 extends along the outer circumference of the connection boss 130 (remote from the axial center of the mounting plate) between the two walls 150 joined to the respective connection boss 130. The second portion 135 can be spaced apart from the rear surface 114 through the thickness of the boss walls, providing windows or cut-outs 140 that, in the example illustrated, open to the respective bore 136 passing through the boss 130. The first (affixed) portion 133 of the proximal end 132 of the boss 130 extends along the inner circumference of the connection boss 130 (proximate the axial center of the mounting plate), between the two walls 150 joined to the boss 130. The cut-outs 140 provide an axial gap in what would otherwise be load bearing material extending continuously between the axial position where the clamp force is transferred from the tie bar to the platen (i.e. along the bayonet in the tie bar boss), and the axial position where the force is transferred from the platen to the mold half (i.e. at the front face of the platen).

Affixing the tie bar connection bosses 130 at the corners 122 of the mounting plate 110 so that at least a portion (i.e. second portion 135) of the proximal end thereof is spaced apart from the mounting plate 110 can help to avoid higher than desired loading at the corners 122 of the mounting plate and lower than desired loading along the margins 120 between the tie bars or along central portions of the mounting plate 110. Reducing or avoiding this “corner loading” can help to reduce or avoid warping, bowing or deformation of the mounting plate 110 and can help to avoid mold flash, mold misalignment, improper mold sealing, or other production problems.

In some examples, each tie bar connection boss 130 may be only connected to the rear face 114 via the respective peripheral walls 150, so that substantially the entire proximal boss end 132 is spaced apart from the rear face 114 of the mounting plate 110. In such examples the tie bar connection bosses are affixed to the mounting plate via the peripheral walls 150.

Considering now the peripheral walls 150 in further detail, each connection boss 130 is joined to two peripheral walls 150 that extend from the outer circumference of the boss 130 at about a 90 degree spacing from each other. A portion of the clamping force exerted by the tie bars on each connection boss 130 (via the locking member 138) is transferred to each of the two peripheral walls joined to each respective boss 130.

Referring to FIG. 4, in the example shown, the moving platen 100 comprises two spaced apart horizontal peripheral walls 150a, 150b, and two spaced apart vertical peripheral walls, 150c, 150d. Each of the walls extends between two of the tie bar connection bosses 130. The peripheral walls 150 extend generally rearwardly from the rear face 114 and define inner and outer wall faces 152, 154. The inner and outer faces 152, 154 are, in the example illustrated, generally parallel to the platen axis 102.

Referring to FIGS. 5 and 6, each peripheral wall 150 also has a height 156 that extends parallel to the platen axis 102, from a proximal wall end 157, joined to the rear face 114 of the mounting plate 110, to the distal wall end 158 of the peripheral wall 150, spaced rearwardly from the proximal wall end. Each peripheral wall 150 additionally has a length 160 generally extending between adjacent tie bar connection bosses 130 and extending parallel to the front face 112.

In some examples, the height 156 of each peripheral wall 150 is constant along its length 160. In other examples, as shown in FIG. 5, the height 156 of each peripheral wall 150 may vary along its length 160. Optionally, a peripheral wall 150 may have a greater height in its middle than at either of its ends, or it may have a smaller height in its middle than at its ends. Each peripheral wall 150 also defines a thickness 162 (shown in FIG. 4), measured as the distance between its inner and outer faces 152, 154. The thickness 162 of a peripheral wall 150 may remain constant along its length 160, or the thickness 162 of the peripheral wall 150 may vary along its length 160. In the example illustrated, the thickness 162 of the peripheral wall 150 is greater nearest the ends of the walls (i.e. at the respective connection bosses 130 between which the wall 150 extends), and is narrower at the midpoint of the wall 150 between the two bosses 130. Further, in the example illustrated, the thickness 162 of the peripheral wall 150 is generally constant along its height.

In some examples, the four peripheral walls 150a-d have the same shape, length, thickness and height. In other examples, at least some of the peripheral walls 150 may have different lengths, heights, thicknesses or any combination thereof. The shape, length, thickness and height of each peripheral wall 150 may optionally be selected based on platen size, expected clamping forces, space constraints, platen material and other suitable factors.

Referring to FIGS. 5 and 6, the peripheral walls 150 may include at least one aperture 164 extending through the wall thickness. The apertures may, as shown, extend through the wall 150 from the inner face 152 to the outer face 154. Providing one or more apertures 164 in the peripheral walls 150 may reduce the amount of material used to create the walls 150 (accompanied by a corresponding reduction in platen weight). The apertures 164 may also allow the distribution of clamping loads along the rear face 114 to be modified (by modifying the size and position of the apertures 164), and may allow utility conduits (e.g. plumbing, hydraulic conduits, electrical cables, etc.) to be fed through the walls 150. In some examples, each peripheral wall 150 may have the same number, shape, position and size of apertures 164, while in other examples, the number, shape, position and size of apertures 164 may vary between peripheral walls 150.

In the example illustrated, each peripheral wall 150 comprises three apertures 164 spaced along its length 160. The apertures 164 are shaped and positioned to provide a distinct distal beam 165 extending along the length of each wall 150 at the distal end 158 thereof, and to provide a plurality of struts 167 extending between the proximal wall end 157 (at the mounting plate) and the distal beam 165. The struts 167 (of which there are two in the example illustrated—one on either side of the central aperture 164) can facilitate distributing the clamping force towards an intermediate area of the margins 120, for example, towards a generally middle region of each margin, between the respective tie bar connection bosses 130.

Referring to FIGS. 4 and 5, in the example shown, the rear face 114 of the mounting plate 110 and the inner faces 152 of the four peripheral walls 150 cooperate to define a platen cavity or volume 171, at least a portion of which forms a central volume 170. The central volume 170 has a depth (or axial extent) 172 which, in some examples, corresponds to the height 156 of the peripheral walls 150.

Referring again to FIG. 2, in the example illustrated, the central volume 170 is sized and configured to receive an ejector plate 182 of an ejector assembly 180. In use, the ejector plate 182 moves axially between advanced and retracted positions, the spacing between which defines an ejector plate stroke length 184 (shown in FIG. 5). The ejector plate 182 can be moved by an ejector actuator 186, which can be a hydraulic cylinder, a ball screw, or similar.

Referring to FIG. 4, in some examples, at least one of the peripheral walls 150 comprises an ejector mount 166 for at least partially supporting the ejector assembly 180. In the present example, the ejector assembly 180 is mounted to the platen 100 via a plurality of ejector mounts 166 formed on the peripheral walls 150.

Arranging the peripheral walls 150 around the perimeter of the mounting plate 110 can facilitate providing a central volume 170 that is sized and shaped so that the ejector plate 182 remains within the central volume 170 in both the advanced and retracted positions. As best illustrated in FIG. 5, in the example illustrated, the depth (or axial extent) 172 of the central volume 170 is greater than the ejector plate stroke length 184. This relationship enables the ejector assembly 180 to remain nested within the central volume 170 during operation, which can simplify packaging of other machine elements near the ejector plate 182, and/or can provide for a more compact platen/ejector assembly, and/or can reduce the overall length of the injection molding machine. In other examples, the central volume depth 172 may be substantially equal to, or less than the ejector plate stroke length 184.

The central volume depth 172 may have a size from about 100 mm to about 400 mm or more. In the example illustrated, the central volume depth (or axial extent) 172 is about 250 mm. The central volume depth 172, ejector plate 182 size and configuration, and ejector plate stroke distance 184 may be selected based on user requirements, mold design, plastic properties, platen material and any other suitable factors.

In some examples, as shown, the central volume 170 may comprise the entire platen cavity 171 defined by the rear face 114 and the four peripheral walls 150. In other examples, a portion of the platen cavity 170 may be occupied by other structural features or elements, in which case the central volume 170 comprises the free space between and/or around the features or elements (i.e. portions of the cavity not otherwise occupied by structural elements). One example of a feature or element that may occupy a portion of the cavity defined by the rear face 114 and the four peripheral walls 150 are buttresses 174, described hereinbelow.

Referring to FIGS. 4 and 5, in some examples, the platen 100 may further comprise one or more buttresses 174 within the platen cavity 171. The buttresses 174 generally comprise wall members or webs that are substantially smaller in thickness are/or in axial extent than the peripheral walls 150. The buttresses can provide protection for services (e.g. hydraulic, pneumatic, or electrical lines) that may be fed through the platen. The buttresses 174 generally occupy a small portion of the platen cavity 171, but remain clear of the central volume 170 in which the ejector assembly is received.

Each buttress may extend rearwardly from the rear face 114 of the mounting plate 110, and laterally from an inner face 152 of the peripheral walls 150. The buttresses 174 extend inwardly from the inner faces 152 of the peripheral walls 150, generally toward the middle of the platen 100, thereby redefining the boundaries of the central volume 170. The buttresses 174 include an axial end 175 or axial connection point that is connected to the rear face 114 of the mounting plate 100 (i.e. lying along the platen axis 102) and at least one lateral end 177 or lateral connection point that is connected to the inner face 152 of the peripheral wall(s) 150. As shown, the buttresses 174 are arcuate members, and are connected at their axial end 175 to the rear face of the mounting plate and laterally to two peripheral walls 150.

Optionally, a platen 100 may include more than one type or configuration of buttress 174 within its central volume 170.

In alternate examples, the features of the moving platen 100 described herein may alternately or additionally be applied to the stationary platen 90.

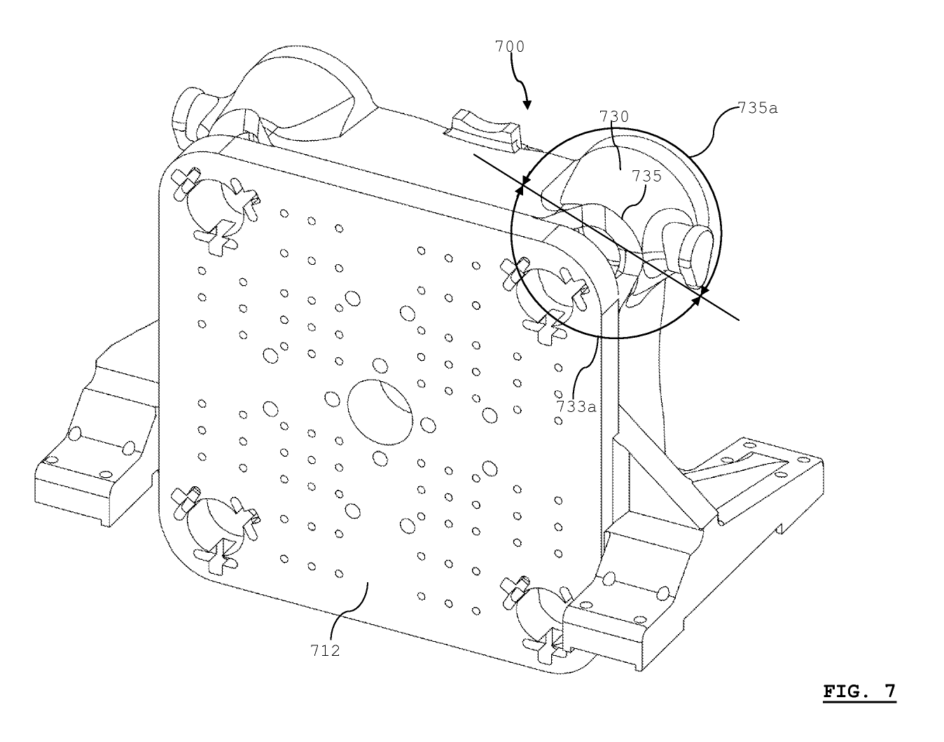

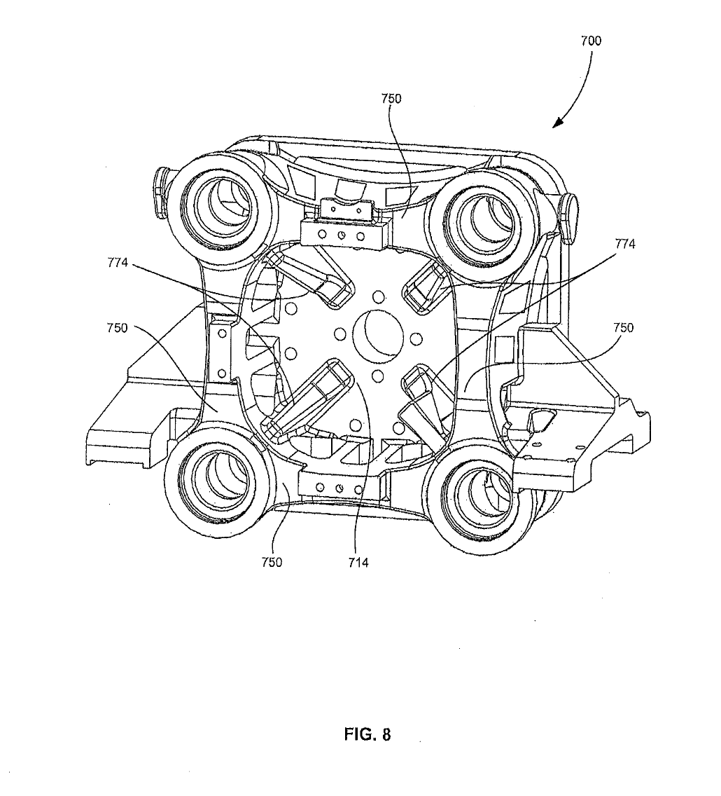

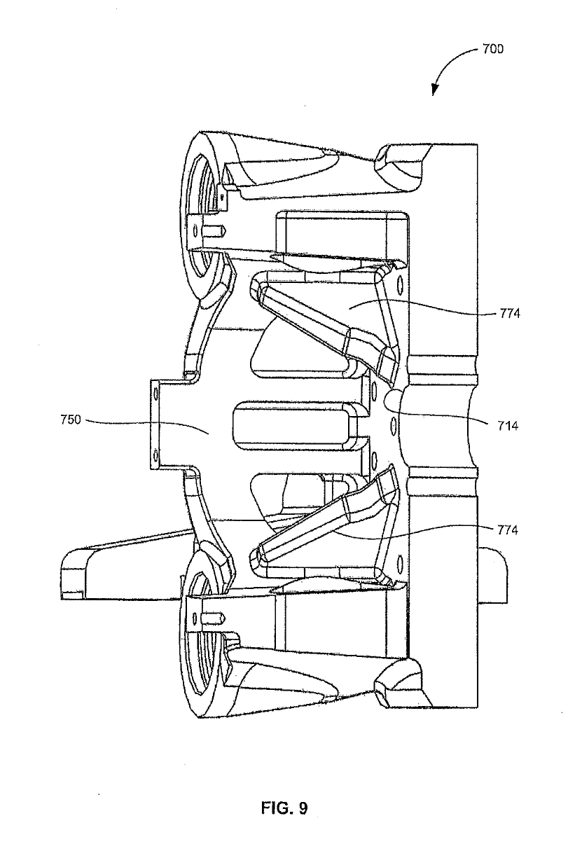

An alternate example of a moving platen 700 is shown in FIGS. 7 to 9, wherein like reference numerals are used to refer to like elements as in FIGS. 1 to 6, with the first digit incremented to 7. In the moving platen 700, the buttresses 774 are angular bracket members, and are connected to a single peripheral wall 750 and the rear face 714. For each tie rod connection boss 730, the first portions 733 of the proximal ends 132 are joined to the rear surface 714 of the mounting plate and have first circumferential extents 733a of about 180 degrees. The second portions 735 have a second circumferential extent 735a of about 180 degrees, opposite the first circumferential extent 733a.

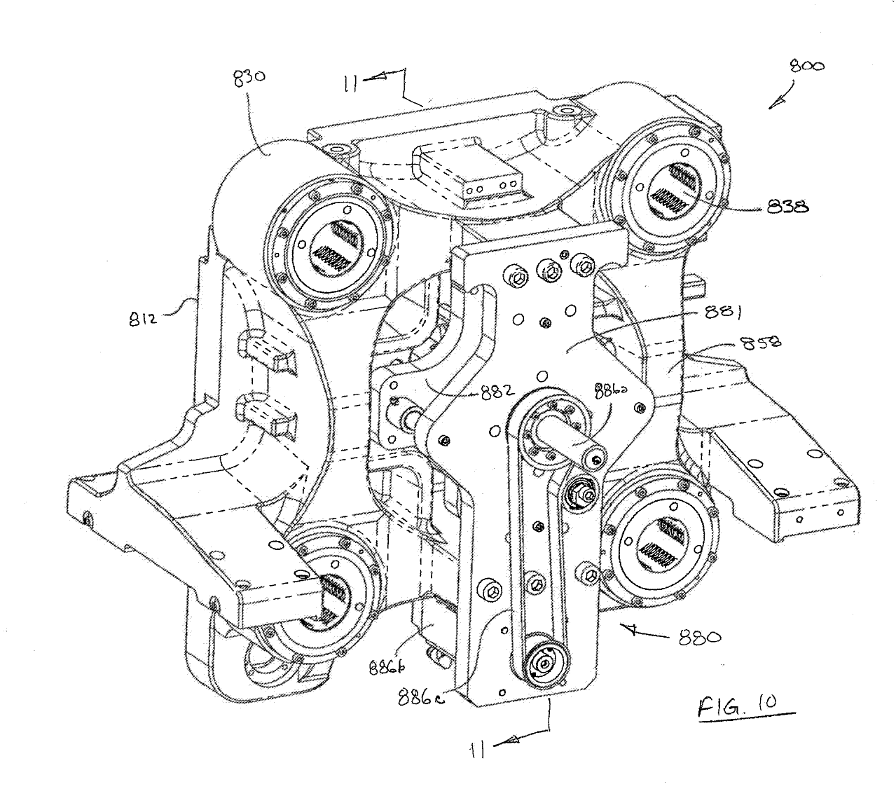

With reference to FIG. 10, another example of a platen 800 is shown in combination with an ejector assembly 880. The platen 800 and ejector assembly 880 are similar to the platen 100 and ejector assembly 180, with like features identified by like reference characters, incremented by 700.

The rear face 814 of the mounting plate 810 and the inner faces 852 of the four peripheral walls 850 cooperate to define a platen cavity or volume 871, at least a portion of which forms a central volume 870. The central volume 870 has a depth (or axial extent) 872 which, in the example illustrated, generally corresponds to the height 856 of the peripheral walls 850.

The ejector assembly 880 includes a backstop 881 that is, in the example illustrated, secured to upper and lower ejector mounts 866. The ejector mounts 866 may be separately attached to, or of integral unitary construction with, respective ones of the peripheral walls 850. The backstop 881 comprises, in the example illustrated, a support plate that is oriented in a generally vertical plane, and fixed relative to the platen 800. In the example illustrated, the backstop 881 includes a lower portion that extends vertically below the outer surface of the lower horizontal one of the peripheral walls 850.

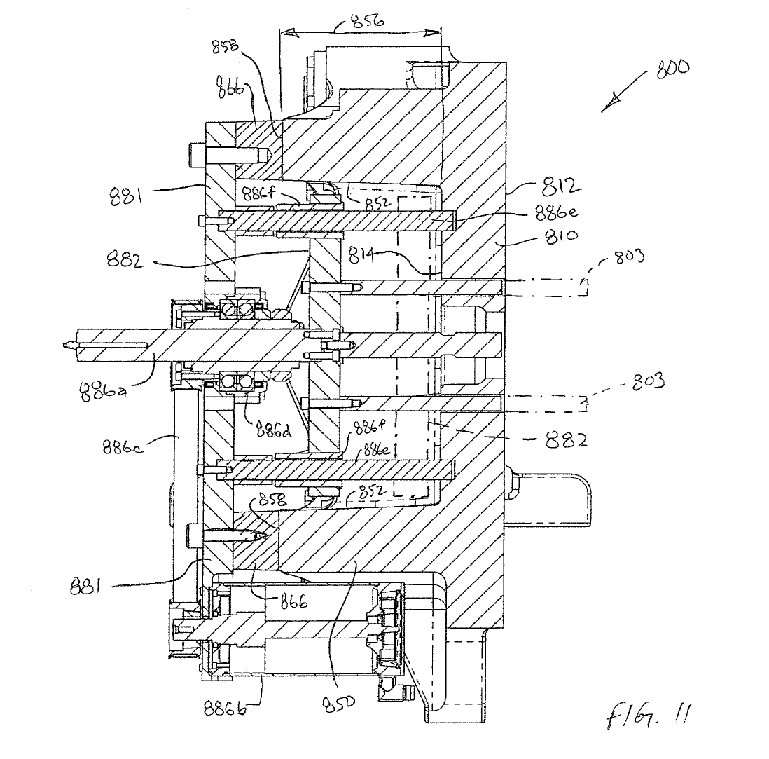

The ejector assembly 880 further includes an ejector plate 882 that can move between advanced and retracted positions for facilitating part ejection from a mold half attached to the platen 800. In the example illustrated, the ejector plate has ejector pins 803 attached to it, the pins protruding through, and forward of, the front face 812 of the mounting plate 810 when the ejector plate is in the advanced position (shown in phantom line in FIG. 11). When in the retracted position (shown in solid line in FIG. 11), the ejector plate 882 is no further rearward than the distal wall end 858 of the peripheral walls 850.

The ejector actuator 886 of the ejector assembly includes, in the example illustrated, a rotary shaft 886a driven by a motor 886b mounted to a lower rear portion of the platen 800 and coupled to the rotary shaft 886a by a belt 886c. Bearings 886d may be fixed to the backstop 881 to support the rotary shaft 886a. A plurality of rods 886e mounted between the backstop and the rear face 814 of the mounting plate 810 (with corresponding bushings 886f slidable therealong and fixed to the ejector plate) can be provided to help guide the axial movement of the ejector plate 880 between the advanced and retracted positions. In the example illustrated, the ejector plate 882 remains within the central volume 870 in both the advanced and retracted positions. The motor 886b is, in the example illustrated, mounted to the lower portion of the backstop 881, and is disposed axially forward of the backstop 881, beneath the lower horizontal peripheral wall at a generally laterally central position thereof.

While the above description provides examples of one or more processes or apparatuses, it will be appreciated that other processes or apparatuses may be within the scope of the accompanying claims.

1. A platen for supporting a mold portion in an injection molding machine, comprising:
a) a mounting plate having a front face for supporting a mold portion, and a rear face spaced apart from the front face, the mounting plate having vertically spaced apart top and bottom horizontal margins and horizontally spaced apart vertical margins, the vertical and horizontal margins generally intersecting at four respective corners of the mounting plate;
b) four tie bar connection bosses affixed adjacent the rear face of the mounting plate, each tie bar connection boss positioned at a respective one of the corners of the mounting plate; and
c) four peripheral walls extending rearwardly from the rear face of the mounting plate for transferring a clamping load from the tie bar connection bosses to the mounting plate, each peripheral wall having a length parallel to the front face and having opposed ends joined to respective adjacent ones of the tie bar connection bosses.

2. The platen of claim 1, wherein each peripheral wall extends generally linearly along a respective one of the margins of the mounting plate.

3. The platen of claim 1, wherein the rear face of the mounting plate and an inner face of each peripheral wall cooperate to define a platen cavity, at least a portion of which defines a central volume for receiving an ejector plate.

4. The platen of claim 3, wherein the central volume has an axial extent that is greater than a stroke length of the ejector plate, so that the ejector plate is received within the axial extent of the central volume in both an advanced and a retracted position.

5. The platen of claim 3, further comprising at least one buttress within the platen cavity, each buttress extending rearward from the rear face of the mounting plate and laterally from an inner face of at least one peripheral wall.

6. The platen of claim 5, wherein each buttress is connected at an axial end to the rear face of the mounting plate and laterally to at least two peripheral walls.

7. The platen of claim 1, wherein bores pass through the mounting plate and the tie bar connection bosses for receiving a respective tie bar therethrough, each bore being parallel to a platen axis extending orthogonal to the front face and having a tie bar locking member adjustably mounted therein for selectively engaging and disengaging the platen relative to the tie bars, and wherein a cut-out is provided around at least a circumferential portion of each boss, each cut out providing an axial gap between the tie bar locking member and the front face of the mounting plate.

8. The platen of claim 7, wherein each tie bar connection boss has a proximal boss end near the mounting plate and a distal boss end spaced rearward of the proximal end.

9. The platen of claim 8, wherein a first portion of each proximal boss end is joined to the rear face of the platen and a second portion of the proximal end is spaced apart from the rear face.

10. The platen of claim 8, wherein each tie bar connection boss is connected to the rear face via the respective peripheral walls and substantially the entire proximal boss end is spaced apart from the rear face of the mounting plate.

11. The platen of claim 1, wherein the four peripheral walls comprise two spaced apart horizontal walls and two spaced apart vertical walls extending between the tie bar connection bosses.

12. The platen of claim 11, wherein each peripheral wall has a height parallel to a platen axis, the height extending orthogonally from a proximal wall end joined to the mounting plate to a distal wall end spaced rearwardly from the proximal wall end.

13. The platen of claim 12, wherein the rear face of the mounting plate and an inner face of each peripheral wall cooperate to define a platen cavity, the platen cavity having a front end substantially closed by the rear face of the mounting plate, and having a substantially open rear end opposite the front end.

14. In combination, a platen assembly for an injection molding machine and an ejector assembly mounted to the platen, comprising:
a) a mounting plate having a front face for supporting a mold portion, and a rear face spaced apart from the front face, the mounting plate having vertically spaced apart top and bottom horizontal margins and horizontally spaced apart vertical margins, the vertical and horizontal margins generally intersecting at four respective corners of the mounting plate;
b) four tie bar connection bosses affixed adjacent the rear face of the mounting plate, each tie bar connection boss positioned at a respective one of the corners of the mounting plate;
c) four peripheral walls extending rearwardly from the rear face of the mounting plate for transferring a clamping load from the tie bar connection bosses to the mounting plate, each peripheral wall having a length parallel to the front face and having opposed ends joined to respective adjacent ones of the tie bar connection bosses; wherein the rear face of the mounting plate and an inner face of each peripheral wall cooperate to define a platen cavity, at least a portion of which defines a central volume; and
d) an ejector plate movable between advanced and retracted positions, the ejector plate disposed within the central volume when in and moving between the advanced and retracted positions.

15. The combination of claim 14, wherein the axial distance between the advanced and retracted positions of the ejector plate defines a stroke length, and wherein the central volume has an axial extent that is greater than the stroke length of the ejector plate, wherein the ejector plate is disposed within the axial extent of the central volume in both the advanced and retracted positions.

16. The combination of claim 14, further comprising a backstop oriented parallel to the mounting face and disposed rearwardly of the platen cavity, the backstop fixed relative to the platen and at least partially supporting a linear actuator for urging the ejector plate between the advanced and retracted positions.

17. The combination of claim 16, wherein the actuator comprises a motor mounted vertically beneath a lower horizontal one of the peripheral walls.

18. The combination of claim 17, wherein the backstop comprises a lower portion extending vertically below the elevation of the lower peripheral wall, and wherein the motor is mounted to the lower portion of the backstop.
